(19) United States
(12) Patent Application Publication
(10) Pub. No.: US 2026/0271905 A1
(43) Pub. Date: Sep. 17, 2026

(54) METHOD, SMART DEVICE AND ELECTRONIC SYSTEM FOR IDENTIFYING LANDING POSITION OF FISHING LURE, MEDIUM AND PROGRAM PRODUCT

(71) Applicant: GUANGDONG COROS SPORTS TECHNOLOGY CO., LTD., Dongguan (CN)

(72) Inventors: Wei ZHANG, Dongguan (CN); Mengbi QIAN, Dongguan (CN)

(73) Assignee: GUANGDONG COROS SPORTS TECHNOLOGY CO., LTD., Dongguan (CN)

(21) Appl. No.: 19/561,876

(22) Filed: Mar. 10, 2026

(30) Foreign Application Priority Data
Mar. 11, 2025 (CN) 202510289472.1

(51) Int. Cl. A01K 97/12; A01K 85/00; G01C 5/06; G01P 15/18

(52) U.S. Cl. CPC A01K 97/125; A01K 85/00; G01C 5/06; G01P 15/18

(57) ABSTRACT

A method for identifying a landing position of a fishing lure includes: obtaining a number of rotations of a fishing reel when the fishing lure is being reeled in through the fishing reel; determining a reeling distance of the fishing lure according to the number of rotations; obtaining a reeling direction of the fishing lure; and determining a cast landing position of the fishing lure according to the reeling distance and the reeling direction. The cast landing position of the fishing lure may be automatically determined based on the data collected by sensors arranged at different positions of a fishing tool without visual observation and manual recording by a user. Accordingly, a fishing experience of the user is improved, and an efficiency and an accuracy of determination of the cast landing position are improved.

### CROSS-REFERENCE TO RELATED APPLICATION

Pursuant to 35 U.S.C. § 119 and the Paris Conversion, this application claims priority to Chinese patent application No. 202510289472.1, filed on Mar. 11, 2025, and entitled “method, device and system for identifying landing position of fishing lure, medium and program product”, the entire contents of which are incorporated herein by reference.

### TECHNICAL FIELD

The present disclosure pertains to the field of fishing technologies, and more particularly, to a method, a smart device and an electronic system for identifying a landing position of a fishing lure, a non-transitory computer-readable storage medium, and a program product.

### BACKGROUND

In fishing sports, lure fishing has become an increasingly popular fishing method. During lure fishing, the cast landing position of the fishing lure in the water often affects a fishing effect. Thus, users usually need to record the cast landing position of the fishing lure to facilitate the establishment of a fishing mode, thereby improving their fishing skills or sharing the fishing process.

Currently, the recording of the cast landing position of the fishing lure generally relies on visual observation and manual recording by a user, which results in low accuracy, poor convenience, and may further affect the user's fishing experience.

Therefore, how to realize accurate and automatic identification of the cast landing position so as to improve the user's fishing experience has become an urgent technical problem to be solved currently.

### SUMMARY

Embodiments of the present disclosure provide a method, a smart device, and an electronic system for identifying a landing position of a fishing lure, a medium, and a program product, which aims at solving the problem of how to achieve accurate and automatic identification of the cast landing position to improve the user's fishing experience.

In one aspect, an embodiment of the present disclosure provides a method for identifying a landing position of a fishing lure, this method is applied to a smart device. The smart device is communicatively connected to a first sensor and a second sensor in a fishing tool. The fishing tool includes a fishing reel and a fishing lure. The first sensor is disposed on the fishing lure, and the second sensor is disposed on the fishing reel. The method includes:
obtaining a number of rotations of the fishing reel when the fishing lure is being reeled in through the fishing reel, the number of rotations is collected by the second sensor;
determining a reeling distance of the fishing lure according to the number of rotations of the fishing reel;
obtaining a reeling direction of the fishing lure, the reeling direction is collected by the first sensor; and
determining the cast landing position of the fishing lure based on the reeling distance and the reeling direction.

The first sensor includes a first magnetometer and a first accelerometer, and the second sensor includes a second accelerometer or a second magnetometer.

In the aforesaid technical solution, the smart device may obtain the reeling direction collected by the first sensor and the number of rotations collected by the second sensor, and determine the reeling distance of the fishing lure based on the number of rotations, thereby automatically determining the cast landing position of the fishing lure according to the reeling distance and the reeling direction. The automatic determination of the cast landing position of the fishing lure is realized without visual observation and manual recording by the user. The user's fishing experience is improved and the efficiency of determination of the cast landing position are improved. Moreover, the first sensor is disposed on the fishing lure, and may collect the accurate reeling direction through the magnetometer and accelerometer thereof. The second sensor is disposed on the fishing reel, and may collect the accurate number of rotations of the fishing reel through the magnetometer or the accelerometer thereof. In this way, the smart device may accurately determine the cast landing position of the fishing lure based on accurate data, thereby improving a detection accuracy of the cast landing position.

In accordance with the second aspect, an embodiment of the present disclosure provides a smart device. The smart device at least includes a processor and a storage medium. The storage medium is configured to store a computer program, and the processor is configured to execute the computer program to implement the method for identifying the landing position of the fishing lure according to any embodiment in the first aspect.

In accordance with the third aspect, an embodiment of the present disclosure provides a method for identifying a landing position of a fishing lure, this method is applied to an electronic system. The electronic system includes a smart device, a first sensor and a second sensor arranged in the fishing tool. The smart device is communicatively connected to the first sensor and the second sensor. The fishing tool includes a fishing reel and a fishing lure. The first sensor is disposed on the fishing lure, and the second sensor is disposed on the fishing reel. The method includes:
controlling the second sensor to collect the number of rotations of the fishing reel when the fishing lure is being reeled in through the fishing reel;
determining the reeling distance of the fishing lure based on the number of rotations of the fishing reel;
controlling the first sensor to collect the reeling direction of the fishing lure; and
controlling the smart device to determine the cast landing position of the fishing lure based on the reeling distance and the reeling direction.

The first sensor includes a magnetometer, and the second sensor includes an accelerometer or a magnetometer.

In accordance with the fourth aspect, an embodiment of the present disclosure provides an electronic system including a smart device, a first sensor in a fishing tool, and a second sensor in the fishing tool. The smart device is communicatively connected to the first sensor and the second sensor. The fishing tool includes a fishing reel and a fishing lure. The first sensor is disposed on the fishing lure, and the second sensor is disposed on the fishing reel. The second sensor is configured to collect the number of rotations of the fishing reel when the fishing lure is being reeled in through the fishing reel. The first sensor is configured to collect the reeling direction of the fishing lure. The smart device includes a processor and a storage medium, and the storage medium is configured to store a computer program. The processor is configured to execute the computer program so as to implement the method for identifying the landing position of the fishing lure according to any embodiment of the third aspect.

In the fifth aspect, an embodiment of the present disclosure provides a non-transitory computer-readable storage medium. The non-transitory computer-readable storage medium stores a computer program, that, when executed by a processor, implements the method for identifying the landing position of the fishing lure according to any embodiment of the first aspect or the third aspect.

In the sixth aspect, an embodiment of the present disclosure provides a computer program product which includes a computer program, that, when executed, causes the method for identifying the landing position of the fishing lure according to any embodiment of the first aspect or the third aspect to be performed.

It should be understood that the beneficial effects of the second aspect, the third aspect, the fourth aspect, the fifth aspect and the sixth aspect may refer to the relevant descriptions in the first aspect, and will not be repeatedly described herein.

### BRIEF DESCRIPTION OF THE DRAWINGS

In order to describe the technical solutions in the embodiments of the present disclosure more clearly, the accompanying drawings used for describing the embodiments or the existing technologies will be briefly introduced. Obviously, the drawings described below are merely some embodiments of the present disclosure. For those of ordinary skill in the art, other drawings may also be obtained from these drawings without creative efforts.

FIG. 1 is a schematic flow diagram of a method for identifying a landing position of a fishing lure in accordance with an embodiment of the present disclosure;

FIG. 2 is a schematic diagram of a fishing application scenario in accordance with an embodiment of the present disclosure;

FIG. 3 is a schematic diagram of determination of the cast landing position of the fishing lure in accordance with an embodiment of the present disclosure;

FIG. 4 is a schematic flow diagram of another method for identifying a landing position of a fishing lure in accordance with an embodiment of the present disclosure;

FIG. 5 is a schematic structural diagram of a smart device in accordance with an embodiment of the present disclosure;

FIG. 6 is a schematic flow diagram of yet another method for identifying a landing position of a fishing lure in accordance with an embodiment of the present disclosure; and

FIG. 7 is a schematic structural diagram of an electronic system in accordance with an embodiment of the present disclosure.

### DETAILED DESCRIPTION OF EMBODIMENTS

In the following description, for the purpose of explanation rather than limitation, specific details such as specific system structures and technologies are set forth below, in order to provide a thorough understanding of the embodiments of the present disclosure. It will be apparent, however, to a person of ordinary skill in the art that the present disclosure may be practiced in other embodiments without these specific details. In other instances, detailed descriptions of well-known systems, devices, circuits, and methods are omitted to avoid obscuring the description of the present disclosure with unnecessary details.

It should be understood that when used in this specification and the appended claims, the term “comprising” indicates the presence of the described features, integers, steps, operations, elements, and/or components, but does not exclude the presence or addition of one or more other features, integers, steps, operations, elements, components, and/or groups thereof.

It is also to be understood that the term “and/or” as used in this specification and the appended claims refers to any combination and all possible combinations of one or more of the associated listed items, and includes such combinations.

As used in this specification and the appended claims, the term “if” may be interpreted as “when . . . ” or “upon . . . ” or “in response to determining” or “in response to detecting” depending on the context. Similarly, the phrase “if it is determined” or “if [a described condition or event] is detected” may be interpreted as “upon determining” or “in response to determining” or “upon detecting [the described condition or event]” or “in response to detecting [the described condition or event]” depending on the context.

In addition, in the description of the specification and the appended claims of the present disclosure, the terms “first”, “second”, “third”, etc. are only used for distinguishing descriptions, and cannot be interpreted as indicating or implying relative importance.

With reference to “one embodiment” or “some embodiments” in the specification of the present disclosure mean that a specific feature, structure, or characteristic described with reference to the embodiment is included in one or more embodiments of the present disclosure. Thus, the phrases “in one embodiment”, “in some embodiments”, “in other some embodiments”, “in still other embodiments”, etc., appearing in different places in this specification, are not necessarily all referring to the same embodiment, but mean “one or more but not all embodiments”, unless otherwise specifically emphasized. The terms “comprising”, “including”, “having” and the variations thereof mean “including but not limited to”, unless otherwise specifically emphasized.

In fishing sports, lure fishing has become an increasingly popular fishing method. In the process of lure fishing, users will make determinations on fish conditions according to the season, the weather, and the underwater terrain environment, and select an appropriate position, fishing lure, and water depth to establish a corresponding “fishing mode” for subsequent review and analysis of the fishing process or sharing.

In the process of lure fishing, users often cast the fishing lure a certain distance to increase the number of catches. Therefore, the cast landing position of the fishing lure in the water has become an important factor affecting the lure fishing experience. Currently, the acquisition of the position during fishing usually relies on a positioning component in the user's mobile terminal, such as a mobile phone or a sports watch, which is used to locate the current position of the mobile terminal. However, the distance between the position located by the positioning component and the cast landing position of the fishing lure is relatively large, and accurate acquisition of the cast landing position of the fishing lure cannot be achieved solely by relying on the positioning component. Therefore, when the user needs to record the cast landing position of the fishing lure, he or she often manually records this position through visual observation, which brings great inconvenience to the user's fishing experience. Moreover, visual observation and manual recording are prone to omissions and errors. Accordingly, the accuracy of the cast landing position of the fishing lure is seriously affected.

In view of the above problems, the present disclosure provides a method for identifying a landing position of a fishing lure. A smart device is provided to obtain the reeling direction of the fishing lure which is collected by the first sensor disposed on the fishing lure through its own magnetometer and accelerometer. A movement direction of the fishing lure may be accurately determined by the magnetometer and the accelerator of the first sensor when the user reels in the fishing lure. Moreover, the smart device is provided to obtain the number of rotations of the fishing reel when the fishing lure is being reeled in through the fishing reel, which is collected by the second sensor of the fishing reel, in order to determine the reeling distance of the fishing lure. In this way, the smart device may quickly and accurately determine the cast landing position of the fishing lure based on the reeling distance and the reeling direction. The entire process is automatically completed without user participation. Accordingly, not only an accurate recording of the cast landing position of the fishing lure is realized, the user's fishing experience is also improved.

The method for identifying the landing position of the fishing lure of the present disclosure will be described below with reference to the embodiments.

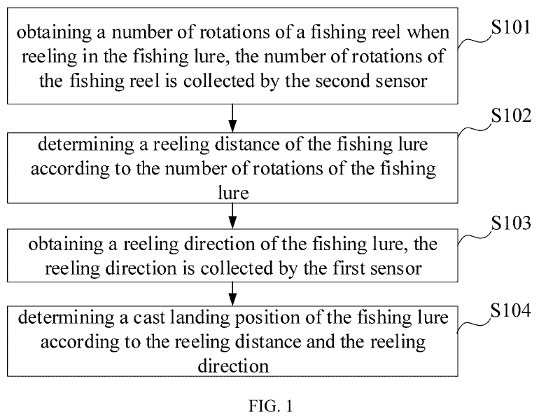

FIG. 1 is a schematic flow diagram of the method for identifying the landing position of the fishing lure 11 according to an embodiment of the present disclosure. The method is applied to a smart device 6 which is communicatively connected to a first sensor 7 and a second sensor 8 in a fishing tool 10. The fishing tool 10 includes a fishing reel 12 and a fishing lure 11. The first sensor 7 is disposed on the fishing lure 11, and the second sensor 8 is disposed on the fishing reel 12. The method includes the following steps:

In a step of S101, the number of rotations of the fishing reel 12 is obtained when the fishing lure 11 is being reeled in through the fishing reel 12. The number of rotations is collected by the second sensor.

The smart device 6 may be a wearable device such as a smart watch, a smart bracelet, or a smart ring, or a terminal device such as a mobile phone, a tablet, or a computer. The type of the smart device 6 is not specifically limited in the embodiments of the present disclosure. The fishing tool 10 may be a fishing rod which is provided with a fishing reel 12, such as a lure rod, a sea rod, or a rock rod. The first sensor 7 includes a magnetometer and an accelerometer, and the second sensor 8 includes an accelerometer or a magnetometer. The first sensor 7 is a streamlined sensor. The magnetometer may be a three-axis magnetometer, and the accelerometer may be a three-axis accelerometer.

The first sensor 7 may be arranged at the position where the fishing lure 11 is hung in the fishing tool 10. For example, the first sensor 7 may be mounted at a hook of the fishing tool 10, or the first sensor 7 may be mounted on the outer surface of the fishing lure 11. The second sensor 8 may be mounted at a handle knob of the fishing reel 12 or on an outer surface of the fishing reel 12, and is mainly used to detect the number of rotations of the fishing reel 12. The specific mounting position of the second sensor 8 is not specifically limited in the present disclosure. When the user reels in the fishing lure 11 through the fishing reel 12, the fishing reel 12 rotates. When the fishing reel 12 rotates, the first acceleration data (and/or first magnetic field strength data) of the fishing reel 12 detected by the second sensor through its own accelerometer (and/or magnetometer) will change periodically. The second sensor 8 may determine whether the fishing reel 12 is rotating based on the detected first acceleration data or the first magnetic field strength data, determine the number of rotations of the fishing reel 12 based on the collected first acceleration data (and/or the first magnetic field strength data) when determining that the fishing reel 12 is rotating, and send the detected number of rotations to the smart device 6. Accordingly, the smart device 6 obtains the number of rotations of the fishing reel 12.

In a step of S102, a reeling distance of the fishing lure is determined according to the number of rotations.

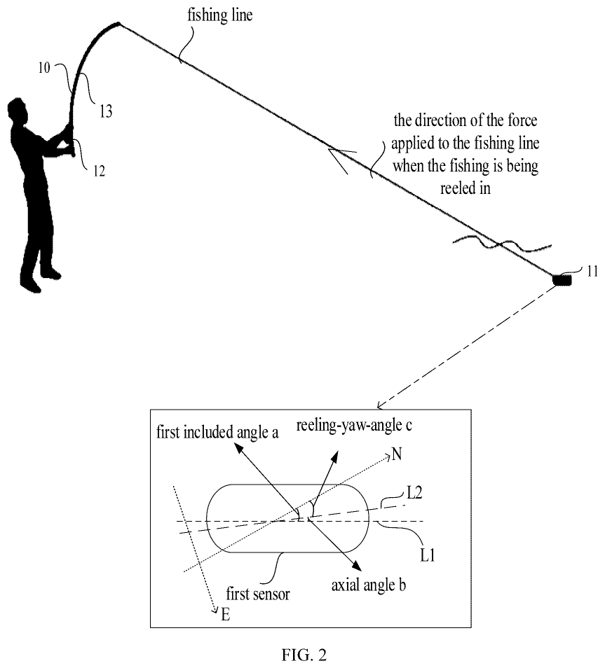

With reference to a schematic diagram of a fishing application scenario shown in FIG. 2, after the user casts the fishing lure into the water, the fishing line of the fishing tool is in a straight state (minor influences, such as water resistance, is ignored), and the length of the fishing line may be regarded as the reeling distance of the fishing lure when the user reels in the fishing lure. In this way, the smart device may determine the circumference of the fishing reel based on the diameter of the fishing reel, and determine the product of the number of rotations and the circumference as the reeling distance of the fishing lure.

In a step of S103, a reeling direction of the fishing lure is obtained. The reeling direction is collected by the first sensor.

The reeling direction of the fishing lure refers to the movement direction of the fishing lure when the fishing reel reels in the fishing lure (i.e., a force direction of the fishing line). The first sensor outputs the reeling direction which is represented by an included angle between the reeling direction of the fishing lure and the geographic north pole direction.

The accelerometer and the magnetometer in the first sensor may be integrated into a single package or laid out on the same circuit board, and output signals of the accelerometer and the magnetometer are integrated and processed through circuit connection and a signal processing circuit, so as to facilitate communication and data transmission with external devices.

The smart device may send a reeling direction acquisition request to the first sensor. The first sensor will detect the second acceleration data and the second magnetic field strength data of the fishing lure based on the reeling direction acquisition request to determine the reeling direction of the fishing lure and return the reeling direction of the fishing lure to the smart device.

The principle of collecting the reeling direction of the fishing lure by the first sensor will be described below with reference to FIG. 2. When the user reels in the fishing lure, reeling of the fishing lure is realized by pulling the fishing line. The fishing line exerts a pulling force on the fishing lure, and the direction of this pulling force is the same as the force direction of the fishing line. Thus, the fishing lure will be pulled back along the force direction of the fishing line. That is, when the user reels in the fishing lure, the movement direction of the fishing lure is consistent with the force direction of the fishing line. The direction indicated by a black arrow on the fishing line in FIG. 2 may represent the movement direction of the fishing lure when the user reels in the fishing lure. At this time, in a horizontal plane coordinate system, an included angle between the movement direction of the fishing lure (i.e., the force direction of the fishing line) and the geographic north pole direction is the included angle between the reeling direction of the fishing lure and the geographic north pole direction.

For the streamlined first sensor, when the user reels in the fishing lure, the axial direction of the first sensor (i.e., the horizontal dotted line L1 in FIG. 2) is consistent with the movement direction of the fishing lure (or the force direction of the fishing line). Therefore, in the horizontal plane coordinate system, the included angle between the reeling direction of the fishing lure and the geographic north pole direction (i.e., the direction indicated by N in FIG. 2, E in FIG. 2 indicates the due east direction which is perpendicular to the direction indicated by N) may be determined by the included angle between the axial direction of the first sensor and the geographic north pole direction. The included angle between the axial direction of the first sensor and the geographic north pole direction may be determined by a yaw angle when the fishing lure is reeled in (i.e., the included angle between the axial direction (indicated by a black dotted line L2) of the magnetometer inside the first sensor and the geographic north pole direction when the fishing lure is reeled in, referred to as a reeling-yaw-angle hereinafter) and a fixed angle between the axial direction of the first sensor itself and the axial direction of the magnetometer inside the first sensor. Therefore, when the first sensor determines the included angle between the reeling direction of the fishing lure and the geographic north pole direction, the first sensor will determine the yaw angle of the fishing lure first based on the collected second acceleration data and the second magnetic field strength data, so as to obtain the required included angle.

It should be noted that the horizontal plane coordinate system is also referred to as the local horizontal coordinate system. The horizontal plane coordinate system in the embodiment of the present disclosure is a two-dimensional coordinate system. The reference axes of the horizontal plane coordinate system are the north axis (N axis, pointing to the geographic north pole direction) and the east axis (E axis, perpendicular to the north axis, pointing to the due east direction).

It should be understood that, for the accuracy of data when calculating the yaw angle of the fishing lure, facilitating data fusion and simplifying calculation, the respective axial directions of the magnetometer and the accelerometer in the first sensor all point to the same direction.

In one embodiment, the process of collecting the reeling direction of the fishing lure by the first sensor includes: during the reeling-in process of the fishing lure by the user, the first sensor may collect the second magnetic field strength data of the fishing lure through the magnetometer and collect the second acceleration data of the fishing lure through the accelerometer; determine the reeling-yaw-angle of the fishing lure based on the second acceleration data and the second magnetic field strength data; determine the sum result between the reeling-yaw-angle and the axial angle of the first sensor. The axial angle refers to an angle between the axial direction of the first sensor itself and the axial direction of the magnetometer inside the first sensor. The determined sum result is used as the first angle between the reeling direction of the fishing lure and the geographic north pole direction. The first angle is subsequently sent to the smart device. In this way, the smart device may obtain the reeling direction of the fishing lure. The reeling-in process of the fishing lure by the user includes a process from casting the fishing lure into the water by the user to pulling the fishing lure out of the water. The first sensor is disposed on the fishing lure, and may accurately collect the magnetic field strength data and the acceleration data when the fishing lure moves through its own magnetometer and accelerometer, and then obtain a reliable and accurate reeling-yaw-angle. Thus, an accurate reeling direction is obtained based on the reeling-yaw-angle, and the accuracy of the cast landing position of the fishing lure is further improved.

By way of example, as shown in FIG. 2, assuming that the fixed angle (the angle between the dotted line L1 and the dotted line L2 in FIG. 2) between the axial direction of the first sensor and the axial direction of the magnetometer inside the first sensor, i.e., the axial angle b of the first sensor, is 15°. During the reeling-in process of the fishing lure by the user, the reeling-yaw-angle c of the fishing lure determined by the first sensor is 45°, i.e., the angle between the dotted line L2 and the geographic north pole direction in FIG. 2 is 45°. The first angle a between the reeling direction of the fishing lure and the geographic north pole direction is (45°+) 15° is equal to 60°, i.e., the included angle between the dotted line L1 and the geographic north pole direction in FIG. 2 is 60°.

In one embodiment, the second acceleration data includes accelerations corresponding to the fishing lure at multiple moments respectively, and the second magnetic field strength data includes the magnetic field strengths corresponding to the fishing lure at multiple moments, respectively. The process of determining the reeling-yaw-angle of the fishing lure by the first sensor based on the second acceleration data and the second magnetic field strength data includes: determining sub-yaw angles corresponding to the fishing lure at multiple moments respectively based on the accelerations and the magnetic field strengths corresponding to the fishing lure at multiple moments respectively; selecting at least one group of sub-yaw angles that meet a preset condition from the sub-yaw angles at multiple moments based on a preset time window; determining mean values of groups of sub-yaw angles, and determining the mean value of the mean values of the groups of sub-yaw angles, and using the determined result as the reeling-yaw-angle of the fishing lure. The preset condition is that a standard deviation among the sub-yaw angles within the preset time window is less than or equal to a preset first difference value.

The preset time window and the preset first difference value may be set according to actual needs. For example, the preset time window may be 5 seconds(S), and the preset first difference value may be 1°. The preset time window and the preset first difference value are not specifically limited in the embodiment of the present disclosure.

By way of example, the first sensor determines the sub-yaw angles corresponding to the fishing lure from a moment A1 to a moment A10 as shown in Table 1 below. The time interval between every two moments of moments A1-A10 is 1 second, the preset time window is 3 seconds, and the preset first difference value is 5°.

TABLE 1

| Moment | A1 | A2 | A3 | A4 | A5 | A6 | A7 | A8 | A9 | A10 |
|---|---|---|---|---|---|---|---|---|---|---|
| Sub-yaw | 70 | 72 | 68 | 71 | 75 | 80 | 78 | 82 | 81 | 79 |
| angle | | | | | | | | | | |

The first sensor slides from time A1 to time A10 with a time window of 3S, determines the standard deviation of the sub-yaw angles in the window that the first sensor currently slides to, determines the average value of the sub-yaw angles in the window that the first sensor currently slides to when the standard deviation is less than or equal to 5°, and finally determines the mean value among all average values after the sliding ends, and takes the determined mean value as the reeling-yaw-angle of the fishing lure. Continuing taking Table 1 as an example, the standard deviation of the sub-yaw angles from time A1 to time A3 (window 1) is less than 5°, and the average value is 70°. Similarly, until window 8 (time A8 to time A10), the standard deviations of the sub-yaw angles in all windows are less than 5°. The average values of the sub-yaw angles under window 2 (time A2 to time A4) to window 8 are 70.3°, 71.3°, 75.3°, 77.7°, 80°, 80.3°, and 80.7° respectively. Thus, the final reeling-yaw-angle is (70+70.3+71.3+75.3+77.7+80+80.3+80.7) °/8≈75.7°.

In the aforesaid technical solution, the first sensor selects at least one group of sub-yaw angles whose standard deviation in the preset time window is less than or equal to the preset first difference value, and determines the reeling-yaw-angle of the fishing lure based on the mean value among the selected groups of sub-yaw angles. When determining the reeling-yaw-angle, the unstable sub-yaw angles (with large or small values) are excluded, and the reeling-yaw-angle is determined by fusing the mean values of the sub-yaw angles in the stable region. In this way, the reliability of the reeling-yaw-angle may be ensured and the accuracy of the reeling direction may be further improved. In addition, during the reeling-in process of the fishing lure, if environmental interference factors such as potholes or rocks are encountered, the axial direction of the first sensor will deviate, and sub-yaw angles with large angle errors is resulted. However, based on the aforesaid technical solution, the sub-yaw angles with large errors caused by environmental interference factors may be filtered out. Thus, a more accurate reeling direction may be obtained.

In one embodiment, the step of determining, by the first sensor, the sub-yaw angles corresponding to the fishing lure at multiple moments respectively based on the accelerations and the magnetic field strengths corresponding to the fishing lure at multiple moments respectively includes: determining pitch angles and roll angles of the fishing lure at multiple moments respectively based on a pitch angle formula, a roll angle formula, and the accelerations of the fishing lure at multiple moments respectively; converting the magnetic field strengths of the fishing lure at multiple moments respectively from a sensor coordinate system to the geographic coordinate system based on the pitch angles and the roll angles of the fishing lure at multiple moments respectively, so as to obtain the converted magnetic field strengths of the fishing lure at multiple moments respectively; determining the sub-yaw angles of the fishing lure at multiple moments respectively based on the yaw angle formula and the converted magnetic field strengths of the fishing lure at multiple moments respectively. In this embodiment of the present disclosure, the acceleration of the fishing lure is taken as the three-axis acceleration vector measured by the three-axis accelerometer, and the magnetic field strength of the fishing lure is taken as the three-axis magnetic field vector measured by the three-axis magnetometer.

The principle that the first sensor determines the sub-yaw angles of the fishing lure at multiple moments respectively based on the accelerations and the magnetic field strengths of the fishing lure at multiple moments respectively will be described below in combination with an example.

Let the acceleration of the fishing lure at a i-th moment be a=(aₓ, a_{y}, a_{z}), and the corresponding magnetic field strength be m=(mₓ, m_{y}, m_{z}), i is a positive integer.

The acceleration a=(aₓ, a_{y}, a_{z}) is substituted into the pitch angle formula to obtain the pitch angle θ=arctan (aₓ/(a_{y}²+a_{z}²)^{1/2}) of the fishing lure at the i-th moment, which is substituted into the roll angle formula to obtain the roll angle φ=arctan (a_{y}/a_{z}) of the fishing lure at the i-th moment. The magnetic field strength m=(mₓ, m_{y}, m_{z}) is converted from the sensor coordinate system to the geographic coordinate system to obtain the converted magnetic field strength m′=(m′ₓ, m′_{y}, m′_{z}). A rotation matrix R, m′=R×m, which is composed of the pitch angle θ and the roll angle φ, needs to be used in this conversion process.

The rotation matrix R is specifically expressed as R=cos θ cos φ sin φ−sin θcos φ −cos θ sin φ cos φ sin θ sin φ. Then, the corresponding values of m′=(m′ₓ, m′_{y}, m′_{z}) is substituted into the yaw angle formula to obtain the sub-yaw angle ψ=arctan 2 (m′_{y}, m′ₓ) of the fishing lure at the i-th moment.

It should be noted that, in the embodiment of the present disclosure, taking the first sensor that independently collects the reeling direction of the fishing lure and sends the reeling direction to the smart device as an example. In a practical application, the first sensor may also send the collected second acceleration data and second magnetic field strength data to the smart device in response to a control instruction of the smart device. The smart device executes the process performed by the first sensor to obtain the reeling direction of the fishing lure. Alternatively, after the smart device controls the first sensor to collect the second acceleration data and the second magnetic field strength data, then, the first sensor executes the above process to send the obtained reeling direction to the smart device.

It should be understood that, after the first sensor determines the pitch angle, the roll angle, and the sub-yaw angle of the fishing lure in the embodiment of the present disclosure, the first sensor may convert its own coordinate system into the required horizontal plane coordinate system based on the determined angles. Then, the final reeling-yaw-angle is determined.

In a step of S104, the cast landing position of the fishing lure is determined according to the reeling distance and the reeling direction.

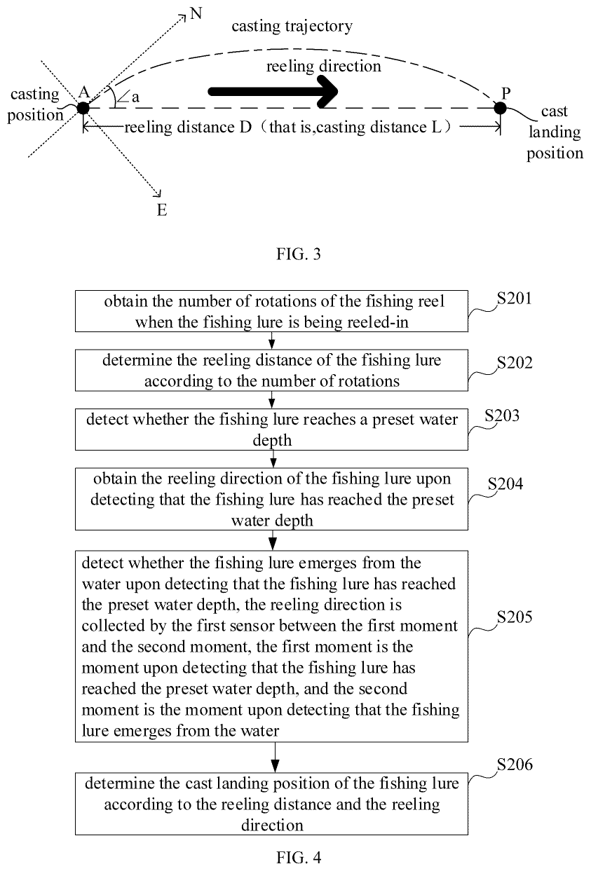

Combined with FIG. 2 and the schematic diagram of determining the cast landing position of the fishing lure in the embodiment of the present disclosure shown in FIG. 3. When the user needs to record the cast landing position of the fishing lure, the user will cast the fishing lure into the water and reel in it immediately. In this process, the smart device may obtain the reeling direction (the first angle between the reeling direction and the geographic north pole direction) collected by the first sensor, and determine the reeling distance of the fishing lure based on the data collected by the second sensor. When the cast landing position of the fishing lure is determined, the casting distance of the fishing lure needs to be determined. Considering that the length of the fishing line pulled back by the user when reeling-in the fishing lure is basically equal to the cast length, the reeling distance of the fishing lure may be regarded as the casting distance of the fishing lure. In addition, the landing position of the fishing lure is relative to the user. In the horizontal plane coordinate system, the first angle is measured from the geographic north pole direction to the due east direction. The user's position may be arranged as the origin of the horizontal plane coordinate system, and the displacement of the cast landing position of the fishing lure relative to the origin may be determined based on the Pythagorean theorem, the reeling distance (the casting distance), and the reeling direction (the first angle between the reeling direction and the geographic north pole direction). Then, the cast landing position of the fishing lure may be determined on the map. The smart device may also synchronize the determined cast landing position of the fishing lure to the user's mobile terminal and the wearable device, so that the user may grasp or share the cast landing position.

In one embodiment, considering that the casting trajectory of the user when casting the fishing lure is mostly similar to a parabola, in order to further improve the accuracy of the cast landing position of the fishing lure, the casting distance of the fishing lure may be obtained based on fitting the reeling distance. For example, the reeling distance may be fitted based on a polynomial fitting function. Let the reeling distance be D and the casting distance be L, then, L=a1*D²+a2*D+a3, in this formula, a1, a2, and a3 are quadratic polynomial fitting coefficients (also referred to as parabolic fitting), and the specific values of a1, a2, and a3 may be determined based on experiments.

In one embodiment, the method further includes:
obtaining the user's casting position, the casting position is the position where the user performs the casting action.

The step of determining the cast landing position of the fishing lure according to the reeling distance and the reeling direction includes:
determining the cast landing position of the fishing lure according to the casting position, the reeling distance, and the reeling direction.

In this technical solution, the cast landing position of the fishing lure determined by the smart device based on the casting position, the reeling distance, and the reeling direction may record the cast landing position of the fishing lure at different casting positions of the user. Thus, it is convenient for the user to review and analyze based on the recorded information and improve their own fishing level. The user's fishing experience is improved, and the entire process is automatically completed by the smart device, and the efficiency of determining the cast landing position of the fishing lure is improved.

The user's casting position may be the position of the wearable device worn by the user, or the position of the main body 13 of the fishing tool 10, the fishing rod, or the fishing reel, etc. In the embodiment of the present disclosure, the wearable device worn by the user is taken as an example.

The wearable device worn by the user may detect whether the user has performed a casting action or a reeling-in action based on the accelerometer and the magnetometer thereof. When detecting that the user has performed the reeling-in action or the casting action, the wearable device will locate the current position of the user based on the positioning component thereof and send the current position as the user's casting position to the smart device. It should be understood that when the smart device is a wearable device worn by the user, the smart device can execute the above steps and directly take the current position of the user located based on its own positioning component as the user's casting position. The positioning component may be a global positioning system (Global Positioning System, GPS) or a BeiDou navigation satellite system (BeiDou Navigation Satellite System, BDS), etc. With further reference with FIG. 3, the smart device may determine the coordinates of the cast landing position of the fishing lure based on the Pythagorean theorem, the reeling distance, and the reeling direction with the casting position as the reference.

By way of example, the principle of determining the cast landing position of the fishing lure will be described with reference to FIG. 3. The direction indicated by the black arrow N in FIG. 3 is the geographic north pole direction. The casting trajectory of the user when casting the fishing lure is shown by the black arc dotted line in FIG. 3. The cast landing position of the fishing lure to be determined is shown by a point P in FIG. 3, and the user's casting position is shown by point A in FIG. 3. The specific coordinates of the point A on the map are (c1, c2). Assuming that the reeling distance obtained by the smart device is D, the reeling distance D is regarded as the casting distance L, and the first angle between the reeling direction and the geographic north pole direction is a. Then, in the horizontal plane coordinate system, the displacement increment of the cast landing position of the fishing lure compared with the point A is L*sin a in the due east direction and is L*cos a in the geographic north pole direction. At this time, the coordinates of the cast landing position point P of the fishing lure are (c1+L*sin a, c2+L*cos a).

In the embodiment of the present disclosure, the smart device may obtain the reeling direction collected by the first sensor and the number of rotations collected by the second sensor, and determine the reeling distance of the fishing lure based on the number of rotations. Accordingly, the cast landing position of the fishing lure may be automatically determined based on the reeling distance and the reeling direction, automatic determination of the cast landing position of the fishing lure may be determined without the need of the user's visual observation and manual recording. Thus, the user's fishing experience is improved, and the efficiency of determining the cast landing position is improved accordingly. Moreover, the first sensor is disposed on the fishing lure, and the first sensor may collect the accurate reeling direction through the magnetometer and the accelerometer thereof. The second sensor is disposed on the fishing reel, and the second sensor may collect the accurate number of rotations of the fishing reel through the magnetometer or the accelerometer thereof. In this way, the smart device may accurately determine the cast landing position of the fishing lure based on accurate data, and the detection accuracy of the cast landing position is improved.

FIG. 4 is a schematic flow diagram of another method for identifying a landing position of a fishing lure according to an embodiment of the present disclosure. The method shown in FIG. 4 includes the following steps S201 to S206:

In the step of S201, the number of rotations of the fishing reel is obtained when the fishing lure is being reeled in through the fishing reel.

In the step of S202, the reeling distance of the fishing lure is determined according to the number of rotations.

The details of the steps S201 to S202 can be referred to the steps S101 to S102 in the embodiment shown in FIG. 1, and will not be repeatedly described herein.

In one embodiment, the method further includes a step of S203.

In the step of S203, whether the fishing lure reaches a preset water depth is detected.

A sensor for detecting water depth, such as an ultrasonic ranging sensor or a laser ranging sensor, may be disposed on the fishing lure. The smart device may obtain data collected by the sensor and determine whether the fishing lure reaches the preset water depth based on the collected data.

For example, the ultrasonic ranging sensor emits an ultrasonic wave into the water. The ultrasonic wave propagates in the water and is reflected back when it encounters a water surface. The ultrasonic ranging sensor receives the reflected ultrasonic signal, determines the distance between the ultrasonic ranging sensor and the water surface by measuring a time interval from the emission of the ultrasonic wave to the reception of the ultrasonic wave, in combination with a propagation speed of the ultrasonic wave in the water. In this way, the water depth is obtained. The smart device may continuously obtain the water depth of the fishing lure collected by the ultrasonic ranging sensor, so as to determine whether the fishing lure reaches the preset water depth based on the detected water depth. The laser ranging sensor may emit a laser signal having high-energy. When the laser signal propagates in the water and encounters the water surface, reflection and scattering will occur. The laser ranging sensor may determine the distance between the laser ranging sensor and the water surface by receiving the reflected laser signal, measuring the time from the emission of the laser signal to the reception of the laser signal, and according to the propagation speed of the laser signal in the water. In this way, the water depth is obtained. The smart device may continuously obtain water depths of the fishing lure collected by the laser ranging sensor to determine whether the fishing lure reaches the preset water depth based on the detected water depths.

In one embodiment, the fishing tool further includes a third sensor disposed on the fishing lure, and the method further includes:
obtaining an air pressure applied to the fishing lure, the air pressure is collected by the third sensor.

The step of detecting whether the fishing lure has reached the preset water depth includes:
determining that the fishing lure has reached the preset water depth, in response to detecting that the air pressure is greater than or equal to the preset first air pressure threshold. The third sensor includes a barometer.

The preset water depth may be freely arranged by the user according to the actual fishing situation, such as weather or tide, which is not specifically limited in the embodiment of the present disclosure. The first air pressure threshold may be pre-determined by the smart device based on the density of water, the preset water depth, and a formula for hydrostatic pressure. For example, the first air pressure threshold may be 1.2 atmospheric pressures (121.56 kilopascals (kPa), corresponding to a water depth of 2 meters) or 1.1 atmospheric pressures (111.43 kPa, corresponding to a water depth of 1 meter). The sensor used to detect the water depth is the third sensor.

The air pressure received by the fishing lure in the water is often greater than that in the air, and different water depths correspond to different air pressure thresholds. The smart device may continuously obtain the air pressure applied to the fishing lure collected by the third sensor through the barometer. When the air pressure is greater than the atmospheric pressure, the smart device may determine that the fishing lure is in the water. At this time, the smart device continues to obtain the air pressure collected by the third sensor, and determines that the fishing lure has reached the preset water depth when detecting that the obtained air pressure is greater than or equal to the preset first air pressure threshold.

It should be noted that theoretically, the fishing lure is in the water when the air pressure applied to the fishing lure is greater than 1 atmospheric pressure. However, in practice, considering the impact of the environmental factors such as weather, the air pressure detected by the barometer in the air may also be greater than 1 atmospheric pressure. Therefore, when the smart device determines whether the fishing lure is in the water, a tolerance may be added. For example, the smart device may determine that the fishing lure is in the water and continue to obtain the air pressure collected by the third sensor when determining that the air pressure received by the fishing lure is greater than 1.01 atmospheric pressures.

In the aforesaid technical solution, the air pressure applied to the fishing lure collected by the third sensor based on the barometer is obtained, and whether the fishing lure reaches the preset water depth may be determined based on a simple comparison between the air pressure and the preset first air pressure threshold. The water depth where the fishing lure is located is determined without complex data processing, the detection efficiency is improved and the efficiency of determining the cast landing position of the fishing lure is further improved.

In one embodiment, the method further includes:
obtaining a duration of the fishing lure at the preset water depth.

The step of determining that the fishing lure has reached the preset water depth in response to detecting that the air pressure is greater than or equal to the preset first air pressure threshold includes:
determining that the fishing lure has reached the preset water depth, in response to detecting that the air pressure is greater than or equal to the first air pressure threshold and the duration is greater than or equal to the preset first duration threshold.

When the smart device detects that the air pressure is less than the preset first air pressure threshold, the smart device will reset the timing duration of its own timer. When detecting that the air pressure is greater than or equal to the preset first air pressure threshold, the smart device will increase the timing duration of the timer thereof, and the timing duration is used as the duration of the fishing lure at the preset water depth. The smart device will determine that the fishing lure reaches the preset water depth only when determining that the air pressure received by the fishing lure is greater than or equal to the first air pressure threshold and the duration is greater than or equal to a preset first duration threshold. The first duration threshold may be set by the user, such as 1S or 3S, which is not specifically limited in the embodiment of the present disclosure.

In the aforesaid technical solution, the fishing lure is determined to reach the preset water depth only when the air pressure applied to the fishing lure is greater than the corresponding first air pressure threshold and the duration of the fishing lure at the preset water depth is greater than the first duration threshold. The combination with the duration may ensure that the change of the air pressure applied to the fishing lure is stable and continuous, and is caused due to the fact the fishing lure has actually reached the preset water depth, rather than temporary environmental fluctuations. Accordingly, the accuracy of determination is improved and the reliability of subsequent acquisition of the reeling direction is further improved.

The step of obtaining the reeling direction of the fishing lure includes a step of S204.

In the step of S204, the reeling direction of the fishing lure is obtained upon detecting that the fishing lure has reached the preset water depth.

When the smart device determines that the fishing lure has reached the preset water depth, the smart device sends a reeling direction acquisition request to the first sensor. The first sensor detects the second acceleration data and the second magnetic field strength data of the fishing lure based on the reeling direction acquisition request to determine the reeling direction of the fishing lure and return it to the smart device. The specific process of determining the reeling direction of the fishing lure by the first sensor refer to the step S103 in the embodiment shown in FIG. 1, and will not be repeatedly described herein.

In one embodiment, the method further includes a step of S205.

In the step of S205, whether the fishing lure emerges from the water is detected upon detecting that the fishing lure has reached the preset water depth. The reeling direction is collected by the first sensor between the first moment and the second moment. The first moment is the moment when detecting that the fishing lure has reached the preset water depth, and the second moment is the moment when detecting that the fishing lure emerges from the water.

When the smart device detects that the fishing lure has reached the preset water depth, in addition to sending a reeling direction acquisition request to the first sensor to enable the first sensor to start collecting the second acceleration data and the second magnetic field strength data from the first moment, the smart device also obtains the data collected by the sensor for detecting water depth, and determines the water depth where the fishing lure is located based on the collected data. When the water depth is less than a specific threshold, it can be determined that the fishing lure has emerged from the water, and a pause instruction is sent to the first sensor. Thus, the first sensor is enabled to pause collecting the second acceleration data and the second magnetic field strength data at the second moment. Moreover, the first sensor is enabled to determine the reeling direction of the fishing lure based on the second acceleration data and the second magnetic field strength data collected between the first moment and the second moment.

In one embodiment, the step of detecting whether the fishing lure emerges from the water includes:
determining whether the fishing lure has emerged from the water according to the air pressure applied to the fishing lure, when detecting that the fishing lure has reached the preset water depth.

When the fishing lure emerges from the water, the air pressure applied to the fishing lure decreases greatly and remains near 1 atmospheric pressure. Therefore, when the smart device detects that the fishing lure has reached the preset water depth, the smart device continues to obtain the air pressure collected by the third sensor, and determines that the fishing lure has emerged from the water when the air pressure is detected to be near 1 atmospheric pressure. The air pressure allows rapid determination regarding whether the fishing lure has emerged from the water, thereby providing a data basis for the subsequent determination of the cast landing position of the fishing lure.

In one embodiment, the step of determining whether the fishing lure has emerged from the water according to the air pressure applied to the fishing lure includes:
determining that the fishing lure has emerged from the water upon detecting that the air pressure applied to the fishing lure is less than a preset second air pressure threshold.

The first air pressure threshold is greater than the second air pressure threshold.

The second air pressure threshold may be 1 atmospheric pressure (101.3 kPa) or slightly greater than 1 atmospheric pressure. The specific value of the second air pressure threshold may be set by the user based on the first air pressure threshold and actual conditions, and is not specifically limited in the embodiments of the present disclosure. The smart device may simply and quickly determine whether the fishing lure has emerged from the water by comparing the air pressure with the second air pressure threshold.

It should be noted that when the user needs to record the cast landing position of the fishing lure, the user may cast the fishing lure into the water to the preset depth, and stay for a period of time for a while, and then immediately reels in the fishing lure through the fishing reel. In this way, it is ensured that the first sensor collects data closely related to the reeling of the fishing lure between the first moment and the second moment, and the accuracy of the reeling direction of the fishing lure is improved accordingly. Certainly, if the user starts fishing after casting the fishing lure into the water to the preset depth and the fishing lure stays in the water for a long time. That is, the time interval between the first moment and the second moment is long, in order to further reduce the influence of the second acceleration data and the second magnetic field strength data of the fishing lure suspended in the water on the determination of the reeling direction, a preset second difference value may also be set. The second difference value is less than the first difference value. The preset condition involved in the step S103 is changed to: the standard deviation between the sub-yaw angles within the preset time window is less than or equal to the preset first difference value and is greater than the second difference value. In this way, it is ensured that the first sensor removes redundant data when determining the reeling direction, and the accuracy of determination of the reeling direction is improved.

In a step of S206, the cast landing position of the fishing lure is determined according to the reeling distance and the reeling direction.

The details of the step S206 can be referred to the step S104 in the embodiment shown in FIG. 1, and will not be repeatedly described herein.

In the embodiments of the present disclosure, the reeling direction of the fishing lure is obtained only upon detecting that the fishing lure has reached the preset water depth. Thus, the first sensor is prevented from continuously collecting data before the fishing lure enters the water, the operating time of the first sensor is reduced, power consumption is conserved, and the service life of the first sensor is prolonged. It is also ensured that the reeling direction is collected after the fishing lure has reaches the relatively stable environment, i.e., the preset water depth, the influence of the casting action or water surface fluctuations on the reeling direction is eliminated before the fishing lure reaches the preset water depth, which is conducive to improving the reliability of the reeling direction and further improving the accuracy of determination of the cast landing position of the fishing lure. In addition, the fishing lure emerging from the water indicates that the fishing lure has been reeled in. The reeling direction collected by the first sensor during the period from a moment when the fishing lure reaches the preset water depth to a moment when the fishing lure emerges from the water may accurately reflect the movement direction of the fishing lure during the reeling process. Accordingly, the accuracy of determination of the cast landing position of the fishing lure is improved. In addition, the reeling direction collected during the period from a moment when the fishing lure reaches the preset water depth to a moment when the fishing lure emerges from the water may also reflect possible reeling directions of the fishing lure in different water areas. Thus, it is beneficial for the user to enrich experience of the fishing lure's movement in different water areas, the user's fishing skills may be improved and the user's fishing experience may be improved accordingly.

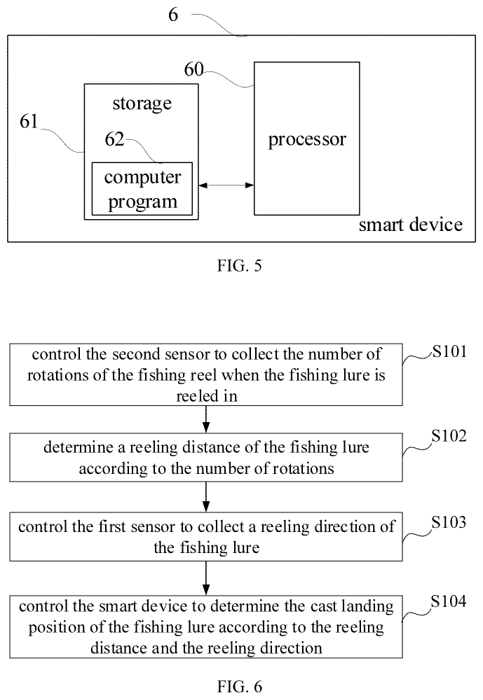

FIG. 5 is a schematic structural diagram of a smart device provided by an embodiment of the present disclosure.

As shown in FIG. 5, the smart device 6 of this embodiment includes: at least one processor 60 (only one is shown in FIG. 5), a storage medium 61, and a computer program 62 stored in the storage medium 61 and executable on the at least one processor 60. When the processor 60 executes the computer program 62, the steps in any of the foregoing embodiments of the method for identifying the landing position of the fishing lure are implemented.

The smart device 6 may be a computer device such as a smart watch or a smart bracelet. The smart device may include, but is not limited to, the processor 60 and the storage medium 61. A person of ordinary skill in the art may understand that FIG. 5 is only an example of the smart device 6 and does not constitute a limitation on the smart device 6. The smart device 6 may include more or fewer components than those shown in FIG. 6, or combine some components, or different components. For example, the smart device 6 may also include an input and output device, a network access device, etc.

The so-called processor 60 may be a central processing unit (CPU), and the processor 60 may also be other general-purpose processor, a digital signal processor (DSP), an application-specific integrated circuit (ASIC), a field-programmable gate array (FPGA) or other programmable logic device, discrete gate or logic device of a transistor, discrete hardware component, etc. A general-purpose processor may be a microprocessor or any conventional processor.

In some embodiments, the storage medium 61 may be an internal storage unit of the smart device 6, such as a memory chip of the smart device 6. In other embodiments, the storage medium 61 may also be an external storage device of the smart device 6, such as a smart media card (Smart Media Card, SMC), a secure digital (Secure Digital, SD) card, a flash card (Flash Card, FC), etc., which are arranged in the smart device 6. Furthermore, the storage medium 61 may also include both an internal storage unit and an external storage device of the smart device 6.

FIG. 6 is a schematic flowchart of another method for identifying a landing position of a fishing lure according to an embodiment of the present disclosure. The method is applied to an electronic system. The electronic system includes a smart device, a first sensor and a second sensor arranged in a fishing tool. The smart device is communicatively connected to the first sensor and the second sensor. The fishing tool includes a fishing reel and a fishing lure. The first sensor is disposed on the fishing lure, and the second sensor is disposed on the fishing reel. The method includes the following steps:

In a step of S301, the second sensor is controlled to collect the number of rotations of the fishing reel when the fishing lure is being reeled in through the fishing reel.

The first sensor includes a magnetometer, and the second sensor includes an accelerometer or a magnetometer.

The electronic system may send a control instruction to the second sensor to control the second sensor to collect first acceleration data (and/or first magnetic field strength data) of the fishing reel, and determine whether the fishing reel is rotated based on the collected data, so as to collect the number of rotations of the fishing reel when the fishing reel reels in the fishing lure.

In a step of S302, the reeling distance of the fishing lure is determined according to the number of rotations.

The details of the step S302 may refer to the step S102 in the embodiment shown in FIG. 1, except that the executive subject of the method is changed from the smart device to the electronic system. Thus, the details of the step S302 will not be repeatedly described herein.

In a step of S303, the first sensor is controlled to collect the reeling direction of the fishing lure.

The electronic system may send a control instruction to the first sensor to control the first sensor to collect the reeling direction of the fishing lure. The specific process of collecting the reeling direction of the fishing lure by the first sensor is similar to the descriptions of the step S103 in the embodiment shown in FIG. 1, and will not be repeatedly described herein.

In a step of S304, the smart device is controlled to determine a cast landing position of the fishing lure according to the reeling distance and the reeling direction.

The details of the step S304 may refer to the step S104 in the embodiment shown in FIG. 1, except that the executive subject of the method is changed from the smart device to the electronic system. Thus, the details of the step S304 will not be repeatedly described herein.

In one embodiment, the method further includes: controlling the smart device to collect the user's casting position. The casting position is the position where the user performs the casting action.

The step of controlling the smart device to determine the cast landing position of the fishing lure according to the reeling distance and the reeling direction includes:
controlling the smart device to determine the cast landing position of the fishing lure according to the casting position, the reeling distance, and the reeling direction.

In one embodiment, the method further includes:
detecting whether the fishing lure has reached the preset water depth.

The step of controlling the first sensor to obtain the reeling direction of the fishing lure includes:
controlling the first sensor to obtain the reeling direction of the fishing lure upon detecting that the fishing lure has reached the preset water depth.

In one embodiment, the fishing tool further includes a third sensor disposed on the fishing lure. The method further includes:
controlling the third sensor to collect the air pressure applied to the fishing lure, the air pressure is collected by the third sensor.

The step of detecting whether the fishing lure has reached the preset water depth includes:
determining that the fishing lure has reached the preset water depth when the air pressure is detected to be greater than or equal to a preset first air pressure threshold.

The third sensor includes a barometer.

In one embodiment, the method further includes following steps:
obtaining a duration of the fishing lure at the preset water depth.

The step of determining that the fishing lure has reached the preset water depth when the air pressure is detected to be greater than or equal to the preset first air pressure threshold includes:
determining that the fishing lure has reached the preset water depth when the air pressure is detected to be greater than or equal to the first air pressure threshold and the duration is greater than or equal to a preset first duration threshold.

In one embodiment, the method further includes:
detecting whether the fishing lure emerges from the water upon detecting that the fishing lure has reached the preset water depth.

The reeling direction is collected by the first sensor between the first moment and the second moment.

The first moment is the moment when detecting that the fishing lure has reached the preset water depth, and the second moment is the moment when detecting that the fishing lure emerges from the water.

In one embodiment, the step of detecting whether the fishing lure emerges from the water includes:
determining whether the fishing lure emerges from the water according to the air pressure applied to the fishing lure, upon detecting that the fishing lure has reached the preset water depth.

In one embodiment, the step of determining whether the fishing lure emerges from the water according to the air pressure applied to the fishing lure includes:
determining that the fishing lure emerges from the water when the air pressure is detected to be less than the preset second air pressure threshold.

The first air pressure threshold is greater than the second air pressure threshold.

Regarding the data collection processes of the first sensor, the second sensor, and the third sensor in the aforesaid embodiments, reference can be made to the corresponding parts in the embodiments shown in FIGS. 1 to 4. The steps performed by the electronic system can refer to the steps performed by the smart device in the embodiments shown in FIGS. 1 to 4, and will not be repeatedly described herein.

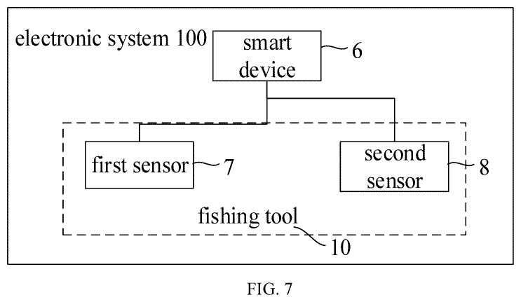

FIG. 7 is a schematic structural diagram of an electronic system according to an embodiment of the present disclosure.

The electronic system 100 includes a smart device 6, a first sensor 7 and a second sensor 8 arranged in the fishing tool. The smart device 6 is communicatively connected to the first sensor 7 and the second sensor 8. The fishing tool includes a fishing reel and a fishing lure. The first sensor 7 is disposed on the fishing lure, and the second sensor 8 is disposed on the fishing reel.

The second sensor 8 is configured to collect a number of rotations of the fishing reel when the fishing lure is being reeled in through the fishing reel.

The first sensor 7 is configured to collect the reeling direction of the fishing lure.

The smart device 6 includes a processor and a storage medium, and the storage medium is configured to store a computer program.

The processor is configured to execute the computer program to implement the method for identifying the landing position of the fishing lure according to any one of the foregoing embodiments.

Embodiments of the present disclosure further provide a computer-readable storage medium. The computer-readable storage medium stores a computer program, that, when executed by a processor, implements the steps in the various method embodiments.

Embodiments of the present disclosure provide a computer program product, that, when executed, causes the method for identifying the landing position of the fishing lure according to any one of the foregoing embodiments to be executed.

All or part of the processes in the methods of the foregoing embodiments may be implemented by a computer program instructing relevant hardware. The computer program may be stored in a computer-readable storage medium. When the computer-readable storage medium is executed by a processor, the steps of the aforesaid various method embodiments are implemented. The computer program includes a computer program code which may be in the form of source code, object code, executable file, or some intermediate form.

In the foregoing embodiments, the description of each embodiment has its own emphasis. For the parts that are not described or recorded in detail in a certain embodiment, reference can be made to the relevant descriptions of other embodiments.

The above embodiments are only used to illustrate the technical solutions of the present disclosure, rather than limiting the technical solutions. Although the present disclosure has been described in detail with reference to the foregoing embodiments, the person of ordinary skill in the art may understand that: they may still modify the technical solutions described in the foregoing embodiments, or equivalently replace some of the technical features. These modifications or replacements do not make the essence of the corresponding technical solutions depart from the spirit and the scope of the technical solutions of the embodiments of the present disclosure, and shall be included within the protection scope of the present disclosure.

What is claimed is:

1. A method for identifying a landing position of a fishing lure, being applied to a smart device, the smart device being communicatively connected with a first sensor and a second sensor arranged in a fishing tool, the fishing tool comprising a fishing reel and a fishing lure, the first sensor being disposed on the fishing lure, the second sensor being disposed on the fishing reel, and the method comprising:
obtaining a number of rotations of the fishing reel when the fishing lure is being reeled in through the fishing reel, the number of rotations of the fishing reel being collected by the second sensor;
determining a reeling distance of the fishing lure according to the number of rotations of the fishing lure;
obtaining a reeling direction of the fishing lure, the reeling direction being collected by the first sensor; and
determining a cast landing position of the fishing lure according to the reeling distance and the reeling direction;
wherein the first sensor comprises a first magnetometer and a first accelerometer, and the second sensor comprises a second accelerometer or a second magnetometer.

2. The method according to claim 1, further comprising:
obtaining a casting position of a user, the casting position being a position where the user performs a casting action;
wherein said determining the cast landing position of the fishing lure according to the reeling distance and the reeling direction comprises:
determining the cast landing position of the fishing lure according to the casting position, the reeling distance and the reeling direction.

3. The method according to claim 1, further comprising:
detecting whether the fishing lure has reached a preset water depth;
wherein said obtaining the reeling direction of the fishing lure comprises:
obtaining the reeling direction of the fishing lure upon detecting that the fishing lure has reached the preset water depth.

4. The method according to claim 3, wherein the fishing tool further comprises a third sensor disposed on the fishing lure, and the method further comprises:
obtaining an air pressure applied to the fishing lure, the air pressure being collected by the third sensor;
wherein said detecting whether the fishing lure has reached the preset water depth comprises:
determining that the fishing lure has reached the preset water depth when the air pressure is detected to be greater than or equal to a preset first air pressure threshold;
wherein the third sensor comprises a barometer.

5. The method according to claim 4, further comprising:
obtaining a duration of the fishing lure at the preset water depth;
wherein said determining that the fishing lure has reached the preset water depth when the air pressure applied to the fishing lure is detected to be greater than or equal to the preset first air pressure threshold comprises:
determining that the fishing lure has reached the preset water depth when detecting that the air pressure applied to the fishing lure is greater than or equal to the preset first air pressure threshold and the duration is greater than or equal to a preset first duration threshold.

6. The method according to claim 3, further comprising:
detecting whether the fishing lure emerges from water upon detecting that the fishing lure has reached the preset water depth;
wherein the reeling direction is collected by the first sensor between a first moment and a second moment;
the first moment is a moment when detecting that the fishing lure has reached the preset water depth, and the second moment is a moment when detecting that the fishing lure emerges from water.

7. The method according to claim 6, wherein said detecting whether the fishing lure emerges from the water comprises:
determining whether the fishing lure emerges from the water according to an air pressure applied to the fishing lure upon detecting that the fishing lure has reached the preset water depth.

8. The method according to claim 7, wherein said determining whether the fishing lure emerges from the water according to the air pressure applied to the fishing lure comprises:
determining that the fishing lure emerges from the water when detecting that the air pressure applied to the fishing lure is less than a preset second air pressure threshold;
wherein the first air pressure threshold is greater than the second air pressure threshold.

9. A smart device, comprising at least a processor and a storage medium;
wherein the storage medium is configured to store a computer program;
the processor is configured to execute the computer program to implement the method for identifying the landing position of the fishing lure according to claim 1.

10. A method for identifying a landing position of a fishing lure, being applied to an electronic system comprising a smart device, a first sensor and a second sensor arranged in a fishing tool, the smart device being communicatively connected with the first sensor and the second sensor, the fishing tool comprising a fishing reel and a fishing lure, the first sensor being disposed on the fishing lure, the second sensor being disposed on the fishing reel, and the method comprising:
controlling the second sensor to collect a number of rotations of the fishing reel when the fishing lure is being reeled in through the fishing reel;
determining a reeling distance of the fishing lure according to the number of rotations of the fishing reel;
controlling the first sensor to collect a reeling direction of the fishing lure; and
controlling the smart device to determine a cast landing position of the fishing lure according to the reeling distance and the reeling direction;
wherein the first sensor comprises a first magnetometer, and the second sensor comprises a first accelerometer or a second magnetometer.

11. The method according to claim 10, further comprising:
controlling the smart device to collect a casting position of a user, the casting position being a position where the user performs a casting action;
wherein said controlling the smart device to determine the cast landing position of the fishing lure according to the reeling distance and the reeling direction comprises:
controlling the smart device to determine the cast landing position of the fishing lure according to the casting position, the reeling distance and the reeling direction.

12. The method according to claim 10, further comprising:
detecting whether the fishing lure has reached a preset water depth;
wherein said controlling the first sensor to obtain the reeling direction of the fishing lure comprises:
controlling the first sensor to obtain the reeling direction of the fishing lure upon detecting that the fishing lure has reached the preset water depth.

13. The method according to claim 12, wherein the fishing tool further comprises a third sensor disposed on the fishing lure, and the method further comprises:
controlling the third sensor to collect an air pressure applied to the fishing lure, the air pressure being collected by the third sensor;
wherein said detecting whether the fishing lure has reached the preset water depth comprises:
determining that the fishing lure has reached the preset water depth when the air pressure is detected to be greater than or equal to a preset first air pressure threshold;
wherein the third sensor comprises a barometer.

14. The method according to claim 13, further comprising:
obtaining a duration of the fishing lure at the preset water depth;
wherein said determining that the fishing lure has reached the preset water depth when the air pressure is detected to be greater than or equal to the preset first air pressure threshold comprises:
determining that the fishing lure has reached the preset water depth when the air pressure is detected to be greater than or equal to the first air pressure threshold and the duration is greater than or equal to a preset first duration threshold.

15. The method according to claim 12, further comprising:
detecting whether the fishing lure emerges from water upon detecting that the fishing lure has reached the preset water depth;
wherein the reeling direction is collected by the first sensor between a first moment and a second moment;
the first moment is a moment when detecting that the fishing lure has reached the preset water depth, and the second moment is a moment when detecting that the fishing lure emerges from water.

16. The method according to claim 15, wherein said detecting whether the fishing lure emerges from the water comprises:
determining whether the fishing lure emerges from the water according to the air pressure applied to the fishing lure upon detecting that the fishing lure has reached the preset water depth.

17. The method according to claim 16, wherein said determining whether the fishing lure emerges from the water according to the air pressure applied to the fishing lure comprises:
determining that the fishing lure emerges from the water upon detecting that the air pressure applied to the fishing lure is less than a preset second air pressure threshold;
wherein the preset first air pressure threshold is greater than the second air pressure threshold.

18. An electronic system, comprising a smart device, a first sensor and a second sensor being arranged in the fishing tool, the smart device being communicatively connected with the first sensor and the second sensor, the fishing tool comprising a fishing reel and a fishing lure, the first sensor being disposed on the fishing lure, and the second sensor being disposed on the fishing reel;
wherein the second sensor is configured to collect a number of rotations of the fishing reel when the fishing lure is being reeled in through the fishing reel;
the first sensor is configured to collect a reeling direction of the fishing lure;
the smart device comprises a processor and a storage medium, the storage medium is configured to store a computer program;
the processor is configured to execute the computer program so as to implement the method for identifying the landing position of the fishing lure according to claim 10.

19. A non-transitory computer-readable storage medium, being configured to store a computer program, the computer program being configured to, when executed by a processor of an electronic system, cause the processor of the electronic system to implement the method for identifying the landing position of the fishing lure according to claim 1.

20. A non-transitory computer readable medium, comprising a computer program that, when executed by a processor of a smart device of an electronic system, causes the processor of the smart device of the electronic system to implement the method for identifying the landing position of the fishing lure according to claim 1.
